(19) United States
(12) Patent Application Publication
(10) Pub. No.: US 2016/0171608 A1
(43) Pub. Date: Jun. 16, 2016

(54) METHODS AND SYSTEMS FOR FINDING SIMILAR FUNDS

(71) Applicant: iMATCHative, Inc., San Francisco, CA (US)

(72) Inventors: Edward Casteel Milner, Dallas, TX (US); Samuel McMillan Hocking, JR., San Francisco, CA (US); Thomas Johannes Oberlechner, San Francisco, CA (US); Peter R. Paradis, San Jose, CA (US); Julia Pitters, Vienna (AT)

(21) Appl. No.: 14/570,656

(22) Filed: Dec. 15, 2014

(51) Int. Cl. G06Q 40/06

(52) U.S. Cl. CPC G06Q 40/06

(57) ABSTRACT

Systems and methods are presented for finding similar funds to a target fund in an investor's financial portfolio. In some embodiments, a method is presented. The method may include accessing target fund characteristics data describing former characteristics of a target fund. The method may also include accessing first comparison fund characteristics data describing present characteristics of a first comparison fund, accessing second comparison fund characteristics data describing present characteristics of a second comparison fund, generating a first difference metric indicating a measure of similarity between the former characteristics of the target fund and the present characteristics of the first comparison fund, generating a second difference metric indicating a measure of similarity between the former characteristics of the target fund and the present characteristics of the second comparison fund, ranking the first and the second difference metrics, and causing display of a visual presentation of the ranking by a graphical display.

### TECHNICAL FIELD

The subject matter disclosed herein generally relates to processing data. In some example embodiments, the present disclosures relate to systems and methods for finding funds similar to an existing financial fund in an investor's financial portfolio.

### BRIEF DESCRIPTION OF THE DRAWINGS

Some embodiments are illustrated by way of example and not limitation in the figures of the accompanying drawings.

FIG. 1 is an example network diagram illustrating a network environment suitable for finding similar funds in a financial product to an existing fund in an investor's financial portfolio, according to some example embodiments.

FIG. 2 is a block diagram illustrating components of a tool for finding similar funds, according to some example embodiments.

FIG. 3 shows an example display of a user interface for finding similar funds to a target fund, according to some example embodiments.

FIG. 4 shows a list of multiple funds that may be most similar to the selected target fund within a specified time range, according to some example embodiments.

FIG. 5 is a flowchart illustrating an example methodology for finding similar funds to a target fund in a user's financial portfolio, according to some example embodiments.

FIG. 6 shows an equation demonstrating in example calculation for a difference metric, according to some example embodiments.

FIG. 7 shows a concrete example of computing a measure of difference or similarity between a target fund and a fund in a database, according to some example embodiments.

FIG. 8 is a block diagram illustrating components of a machine, according to some example embodiments, able to read instructions from a machine-readable medium and perform any one or more of the methodologies discussed herein.

### DETAILED DESCRIPTION

Example methods, apparatuses, and systems are presented for finding similar products to an existing product based on various statistics about the existing and similar products. In some example embodiments, the example methods, apparatuses, and systems may be applied to finding funds in financial investment products that are similar to an existing financial fund in an investor's financial portfolio. In some example embodiments, a tool for finding similar funds is presented that accesses various statistics about the investor's existing fund and compares the existing fund's statistics to other statistics about other funds in a database. In some example embodiments, a similarity score for each fund in the database is generated, the similarity score representing how similar each fund in the database is to the investor's existing fund based on an aggregate of the statistics. In some example embodiments, the tool causes a display of the most similar fund compared to the investor's existing fund. In some cases, the tool causes a display of a ranked list of the most similar funds to the investor's existing fund.

In some example embodiments, the tool can find a fund that presently behaves similarly to how the investor's existing fund behaved during some specified period in the past. For example, the investor may have favored the performance of the existing fund during its initial growth stages, while the existing fund has now matured and does not grow in the same way it once did. The tool, according to aspects of the present disclosure, can compare various statistics of the investor's existing fund during the specified time period to present statistics of other funds in order to determine which funds may presently behave similarly to the investor's existing fund during the specified time period.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

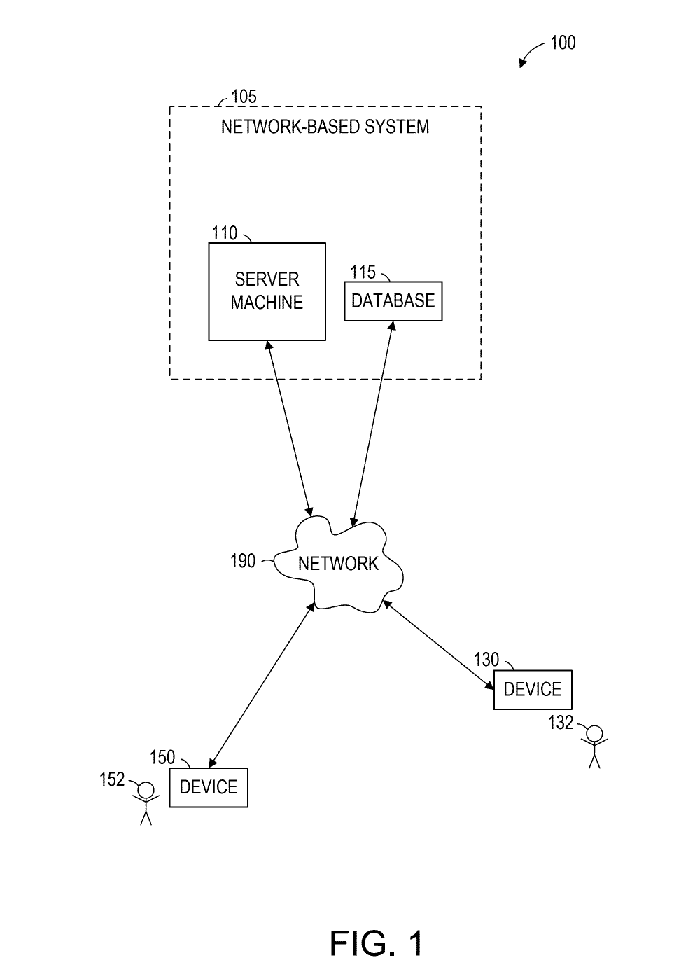

Referring to FIG. 1, an example network diagram is shown, illustrating a network environment 100 suitable for finding similar funds in financial products to an existing fund in an investor's financial portfolio, according to some example embodiments. As used herein, a financial product can refer to an agreement between an investor and an investment entity used to manage money of the investor. A financial product may define a structure and set of rules for managing the money and may include financial capital from the investor. Financial products typically may be governed by financial laws and regulations. Examples of a financial product can include a hedge fund, bond, stock, mutual fund, insurance policy, and the like. As used herein, a fund can refer to an amount of capital belonging to numerous investors that is used to collectively purchase securities while each investor retains ownership and control of his or her own shares. Typically, investors do not make decisions about how a fund's assets should be invested. A fund manager usually oversees the fund and makes investment decisions, including, for example, which securities it should hold in what quantities, and when they should be bought and sold. Examples of funds include mutual funds, exchange traded funds, money market funds and hedge funds.

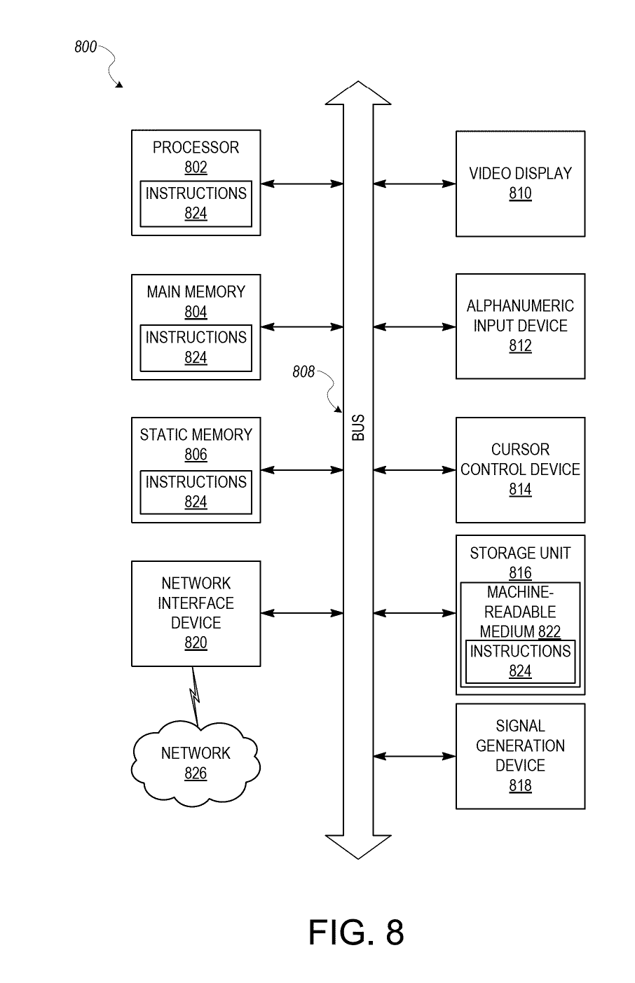

The example network environment 100 includes a server machine 110, a database 115, a first device 130 for a first user 132, and a second device 150 for a second user 152, all communicatively coupled to each other via a network 190. The server machine 110 may form all or part of a network-based system 105 (e.g., a cloud-based server system configured to provide one or more services to the first and second devices 130 and 150). The server machine 110, the first device 130, and the second device 150 may each be implemented in a computer system, in whole or in part, as described below with respect to FIG. 8.

Also shown in FIG. 1 are the first user 132 and the second user 152. One or both of the first and second users 132 and 152 may be a human user, a machine user (e.g., a computer configured by a software program to interact with the first device 130), or any suitable combination thereof (e.g., a human assisted by a machine or a machine supervised by a human). The first user 132 may be associated with the first device 130 and may be a user of the first device 130. For example, the first device 130 may be a desktop computer, a vehicle computer, a tablet computer, a navigational device, a portable media device, a smartphone, or a wearable device (e.g., a smart watch or smart glasses) belonging to the first user 132. Likewise, the second user 152 may be associated with the second device 150. As an example, the second device 150 may be a desktop computer, a vehicle computer, a tablet computer, a navigational device, a portable media device, a smartphone, or a wearable device (e.g., a smart watch or smart glasses) belonging to the second user 152.

Any of the machines, databases 115, or first or second devices 130 or 150 shown in FIG. 1 may be implemented in a general-purpose computer modified (e.g., configured or programmed) by software (e.g., one or more software modules) to be a special-purpose computer to perform one or more of the functions described herein for that machine, database 115, or first or second device 130 or 150. For example, a computer system able to implement any one or more of the methodologies described herein is discussed below with respect to FIG. 8. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases 115, and devices (e.g., the server machine 110 and the first device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

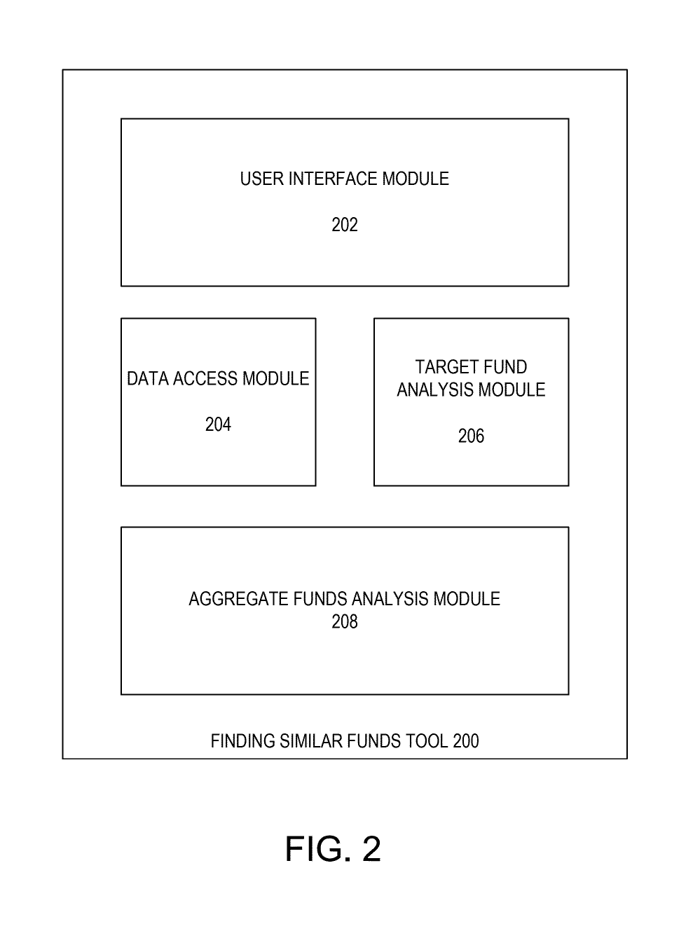

Referring to FIG. 2, a block diagram illustrating components of a tool 200 for finding similar funds is shown, according to some example embodiments. The finding similar funds tool 200 may be an example of an application, program, or computer system in the network-based system 105 of FIG. 1, e.g., may be a part of the server machine 110, and may be suitable for finding one or more funds that behave similarly to a target fund. The finding similar funds tool 200 can include a user interface module 202, data access module 204, target fund analysis module 206, and aggregate funds analysis module 208, which may all be configured to communicate with each other (e.g., via a bus, shared memory, a switch). The finding similar funds tool 200 can communicate with the database 115 of FIG. 1, for example, through the data access module 204. The data access module 204 can also access some data supplied by the user, for example first user 132, through the user interface module 202. The target fund analysis module 206 and aggregate funds analysis module 208 can be configured to process the data provided by the data access module 204. The processed data can then be displayed in the user interface module 202.

In some example embodiments, the target fund analysis module 206 can be configured to analyze various statistics or other fund characteristics of a target fund specified by the first user 132. The various statistics or other fund characteristics of the target fund can then be compared against various corresponding statistics or other characteristics of other funds. The statistics and other fund characteristics of the other funds can be generated and analyzed in the aggregate funds analysis module 208, according to some example embodiments. The aggregate funds analysis module 208 can access any and all other funds via the data access module 204, the other funds stored in database 115 for example, and rank how all the other various funds compare to the target fund. The most similar or set of most similar funds can then be displayed via the user interface module 202. Examples of other types of characteristics describing a fund besides quantitative statistics will be discussed in more detail below.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. Each of the various modules described herein can be implemented at least in part by one or more processors in one or more servers of the network-based system 105 (e.g., in the server machine 110).

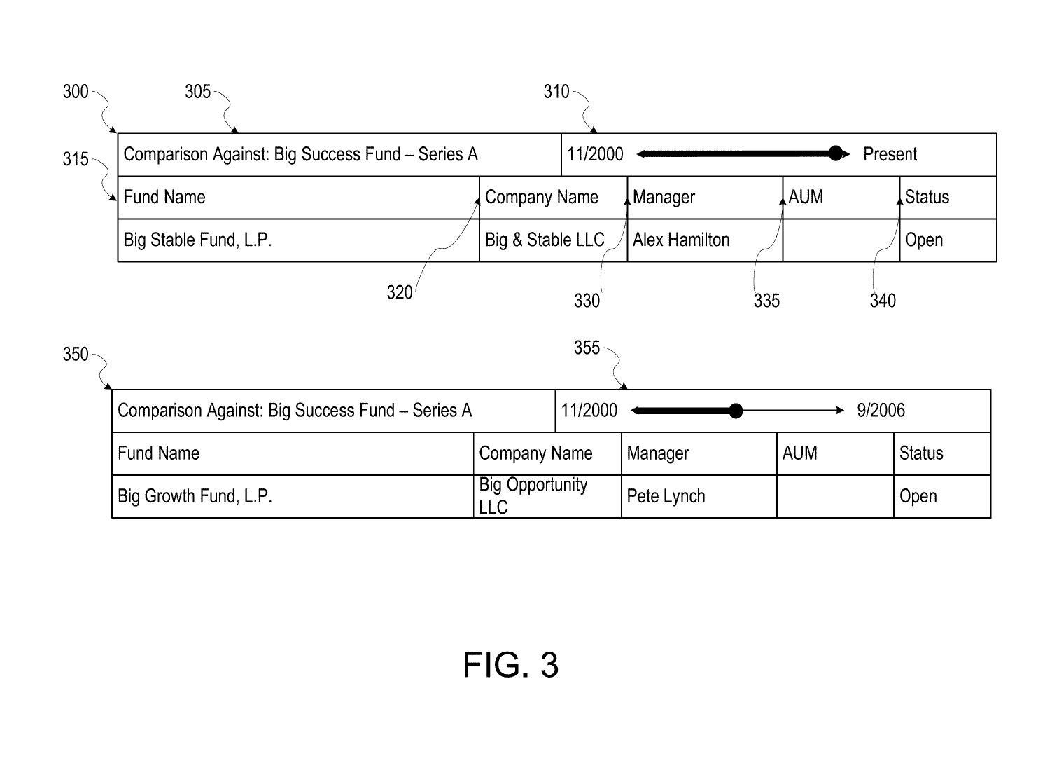

Referring to FIG. 3, illustration 300 shows an example display of a user interface for finding similar funds to a target fund, according to some example embodiments. Illustration 300 may be displayed by the user interface module 202, for example. Here, an investor such as the first user 132 may be prompted to enter a target fund for comparison against various other funds in the prompt box 305. For example, the user 132 may enter “Big Success Fund—Series A,” where the prompt box 305 prompts the first user 132 to enter a fund for “Comparison Against.” The selected target fund may be a fund currently available in the first user's 132 financial portfolio, which may be accessible in the database 115, for example. In other cases, the selected target fund may not be owned in whole or in part by the first user 132. Instead, the first user 132 may have learned about the success of the selected target fund and may want to learn what other funds may be similar in its behavior or performance. In some example embodiments, the first user 132 may also be able to specify a time range of the selected target fund for comparison with the other various funds, using the slider tool 310. Here, the first user 132 has selected the time range for comparison to be from November 2000 to the present. Thus, the finding similar funds tool 200, according to aspects of the present disclosure, may determine which funds among the various funds being searched have a present behavior or performance that is most similar to how the selected target fund behaved within the specified time range.

In some example embodiments, the finding similar funds tool 200 may provide a response by displaying a fund that is most similar to the selected target fund. For example, the fund name 315 may be displayed, e.g., “Big Stable Fund, L.P.” In addition, the company name 320 of the company managing the fund may be displayed, e.g., the “Big & Stable LLC.” Furthermore, the manager 330 of the fund may also be displayed, e.g., “Alex Hamilton.” In some cases, information about assets under management (AUM) 335 may be provided, as well as a status indicator 340 displaying whether the fund can be invested in or not. In this case, the “Big Stable Fund, L.P.” can be invested in, since the status indicator 340 states the fund is “open.”

As another example, illustration 350 shows a different fund that is most similar to the selected target fund, based on a different time range. Here, the time range of the Big Success Fund specified to be compared against is between November 2000 and September 2006. In some example embodiments, the user 132 may click the slider tool 355 and drag it along the Big Success Fund's entire range of existence until the user 132 reaches the desired time range. In some example embodiments, the user 132 may also manipulate the slider bar 355 from the left side, indicating some time range that does not start from the beginning of the target fund's existence. Specifying a particular time range of the selected target fund can allow the user 132 to focus on a particular period of growth that the user 132 wants to emulate in one or more other funds. For example, the user 132 having changed the time range using slider tool 355, a different fund is now displayed, e.g., the “Big Growth Fund, L.P.” This fund also has a different company name and manager, as shown.

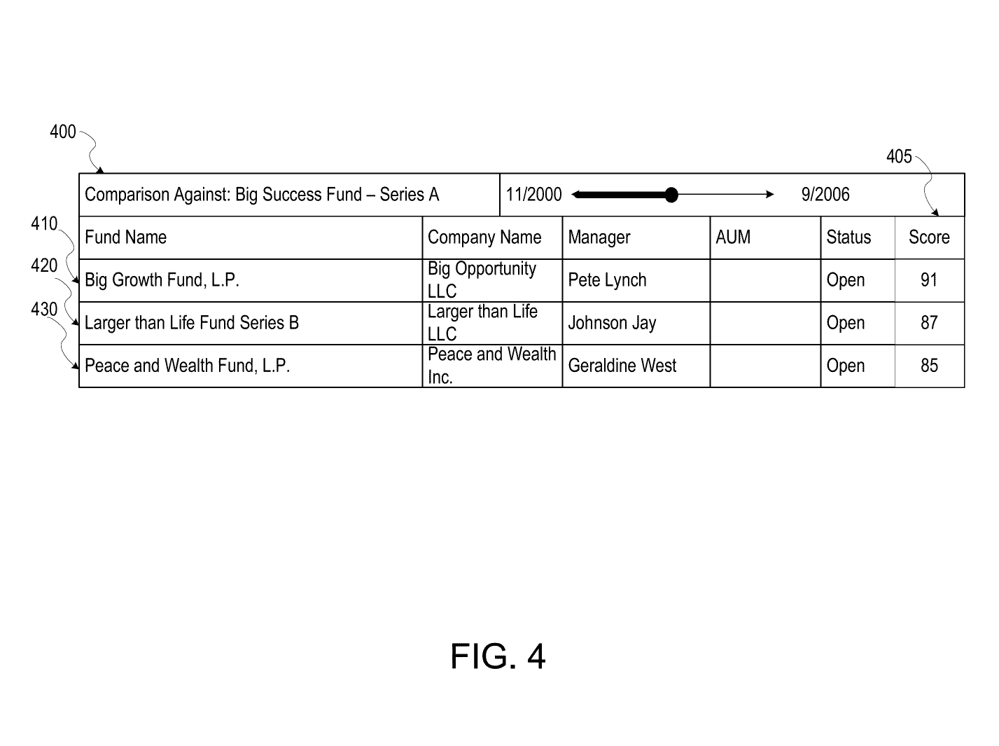

Referring to FIG. 4, illustration 400 shows a list of multiple funds that may be most similar to the selected target fund, e.g., the “Big Success Fund—Series A,” within the specified time range, according to some example embodiments. While the selected target fund and the specified time range are the same as in illustration 350, here, multiple funds 410, 420, at 430 are listed, with an additional score column 405 indicating a measure of closeness or similarity to the selected target fund for each listed fund. Here, the funds 410, 420, and 430 are displayed in descending order from most similar to least similar. The score column 405 can list scores that may range from 0 to 100, in some example embodiments. In this way, the user 132 may be able not only to see which funds may be most similar to the selected target fund within the specified time range, but also to assess how close or similar the most similar funds may be.

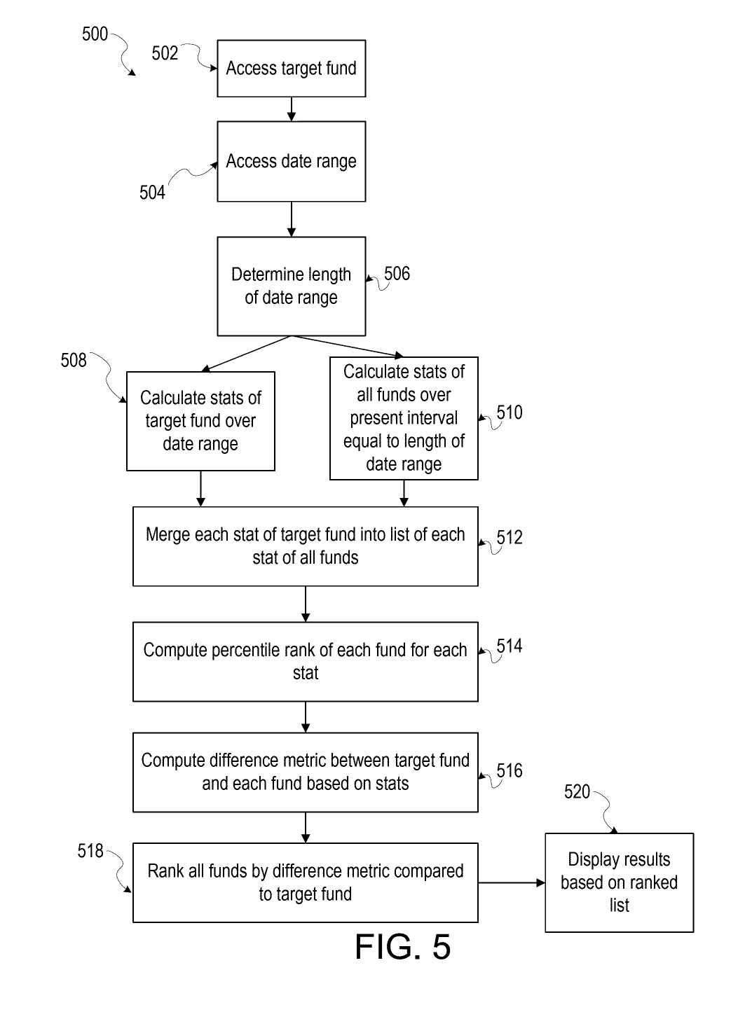

Referring to FIG. 5, the flowchart illustrates an example methodology 500 for finding similar funds to a target fund in a user 132's financial portfolio, according to aspects of the present disclosure. The example methodology 500 may be directed from the perspective of a network-based system (e.g., network-based system 105) configured to access data about a target fund and various other funds and to display the most similar funds to the target fund in a user interface. In some example embodiments, the finding similar funds tool 200 may be configured to perform the operations described in methodology 500.

At operation 502, the network-based system 105 may access a target fund for comparison with other existing funds. In some example embodiments, the data access module 204 within the finding similar funds tool 200, e.g., residing in the network-based system 105, may perform this operation. The target fund may be specified by a user, e.g., the user 132, through an interface, such as user interface module 202 or any of the examples in FIGS. 3 and 4. The network-based system 105 may then access the target fund in a database, e.g., database 115 via data access module 204, based on the name of the fund entered by the user 132.

At operation 504, in some example embodiments, the network-based system 105 may access a date range to define a time period of the target fund for comparison with the other existing funds. In some example embodiments, the data access module 204 within the finding similar funds tool 200, e.g., residing in the network-based system 105, may perform this operation. In some example embodiments, the date range may be specified via the methods described in FIGS. 3 and 4. In other cases, the date range may be specified through the user 132 typing in the date range or selecting a series of dates in various pulldown menus. The network-based system 105 may then access the date range specified by the user 132 via the user interface module 202. In some example embodiments, a date range may not be used or specified, and in these cases, the network-based system 105 may set the date range to be the entire history of the target fund.

At operation 506, the network-based system 105 may determine or compute the length of the date range. Techniques for determining the length of the date range may include computer-based date subtraction techniques, or other techniques apparent to those with skill in the art. In some example embodiments, the target fund analysis module 206 and/or the aggregate funds analysis module 208 within the finding similar funds tool 200, e.g., residing in the network-based system 105, may perform this operation.

In some example embodiments, two sets of operations may happen in parallel after operation 506. For example, at operation 508 the network-based system 105 may calculate statistics of the target fund over the date range. Examples of the various statistics will be described in more detail below. In some example embodiments, the target fund analysis module 206 within the finding similar funds tool 200, e.g., residing in the network-based system 105, may perform this operation. In some example embodiments, in parallel, the network-based system 105 may calculate the same statistics of all of the other funds used for comparison over a present time interval equal to the length of the date range. In some example embodiments, the aggregate funds analysis module 208 within the finding similar funds tool 200, e.g., residing in the network-based system 105, may perform this operation. For example, if the user 132 specified a date range between January 2000 and January 2003, then the length of the date range would be three years, and operation 510 will calculate various statistics of all of the other funds over the time interval of the last three years. This is because the user 132 may desire to find a fund that is presently operating most similarly to how the target fund operated during the specified date range that may have occurred in the past. In some example embodiments, operations 508 and 510 can be performed serially, and embodiments are not so limited.

At operation 512, after having calculated the statistics for the target fund and for all of the other funds used for comparison, the network-based system 105 may merge each statistic of the target fund into a respective list for each statistic of all of the other funds. In some example embodiments, the target fund analysis module 206 and/or the aggregate funds analysis module 208 within the finding similar funds tool 200, e.g., residing in the network-based system 105, may perform this operation. The list for each statistic may be stored in the database 115; for example the data access module 204 may be configured to transmit the calculated stats from both the target fund analysis module 206 and the aggregate funds analysis module 208 to the database 115, for example. In some example embodiments, the merging of the statistics can include storing each statistic of the target fund into the corresponding respective list for each statistic of all of the other funds.

At operation 514, the network-based system 105 may compute a percentile rank of each fund for each statistic, in some cases using the merged list of statistics from operation 512. In some example embodiments, the target fund analysis module 206 and/or the aggregate funds analysis module 208 within the finding similar funds tool 200, e.g., residing in the network-based system 105, may perform this operation. For example, for a particular list storing the same statistic for all funds, the network-based system 105 may first order that list in, e.g., ascending or descending order. Then, each fund may be ranked in the list based on the ordering of the statistic associated with that list. In some example embodiments, the ranking may be normalized as a percentile ranking. This process may be repeated for each list, i.e, each statistic associated with its list. Operation 514 also includes determining the percentile rank of the target fund for each particular statistic. For example, for a list ranking a statistic of standard deviation of returns, the target fund may be ranked in the 55^{th} percentile compared to all other funds, while for a list ranking a statistic of asset growth, the target fund may be ranked in the 32^{nd} percentile compared to all other funds.

At operation 516, the network-based system 105 may compute a difference metric for each pairwise comparison of the target fund and each fund among the aggregate funds, each difference metric based on the statistics of the target fund and the statistics of each fund among the aggregate funds. In some example embodiments, the target fund analysis module 206 and/or the aggregate funds analysis module 208 within the finding similar funds tool 200, e.g., residing in the network-based system 105, may perform this operation. In other words, a measure of difference or similarity between the target fund and each fund among the aggregate funds is computed, where the measure of difference or similarity is based on an aggregate of how similar or different the target fund's statistics are to the statistics of each fund among the aggregate funds. In some example embodiments, the difference metric is based on the percentile ranking of the statistics for both the target fund and each fund among the aggregate funds. An example application of this will be described below.

At operation 518, the network-based system 105 may rank all of the funds based on the computed difference metrics compared to the target fund. In some example embodiments, a smaller difference metric value means that the fund among the aggregate funds is more similar to the target fund, while a larger difference metric value means that the fund is more different than the target fund. In some example embodiments, the target fund analysis module 206 and/or the aggregate funds analysis module 208 within the finding similar funds tool 200, e.g., residing in the network-based system 105, may perform this operation.

Having now computed in order a list of the funds based on a ranking of their difference metrics, at operation 520, the network-based system 105 may display the results based on the ranked list. The display may be shown in the user interface module 202 within the finding similar funds tool 200, for example. In some example embodiments, the display results may show only those funds that are most similar to the target fund. In other cases, the display results may show several of the most similar funds, including a score illustrating or indicating how similar each of the funds are to the target fund. In some example embodiments, computing the score may be based on the difference metrics. For example, the difference metrics may be expressed as a raw value, while the score may be based on a normalization of a ranking or ordering of the raw values. Examples of the display results can include the illustrations in FIGS. 3 and 4.

In some example embodiments, the techniques described herein may be applied to scenarios generally where it is desirable to identify comparable entities in asynchronous time periods. Examples can include finding similar investments in other types of financial instruments, such as stocks, bonds, mutual funds, companies, private equity, and the like; investments in real assets such as real estate, collectable items, automobiles, wine, art, and the like; identifying promising employees, athletes, performers, and the like; identifying epidemics and diseases, etc.; and identifying and predicting facial characteristics at different ages.

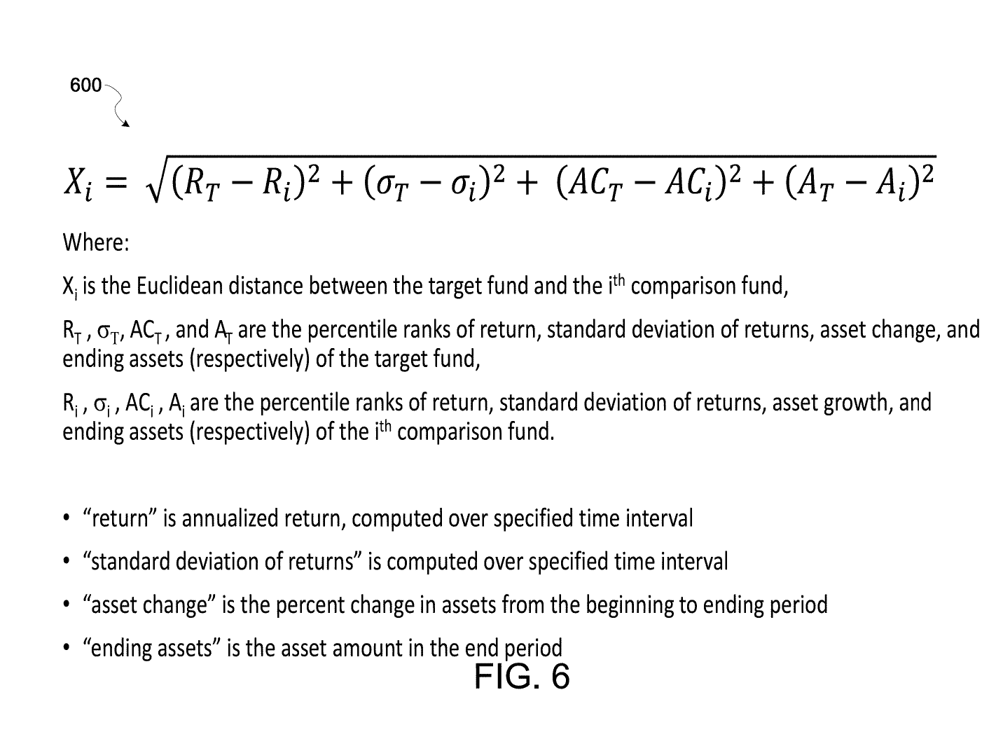

Referring to FIG. 6, equation 600 demonstrates an example calculation for a difference metric, described in FIG. 5 and according to some example embodiments. Here, the example difference metric Xᵢ between a target fund T and a fund i is a calculation of Euclidean distance between the target fund T and the fund i, e.g., the i^{th} fund in a database, e.g., database 115, referred to herein as a comparison fund. The example equation 600 computes the Euclidean distance based on four statistics: a percentile rank of return R, a standard deviation of returns σ, a measure of asset change AC, and a value of ending assets A. Each of the four statistics may have been computed for both the target fund T and the fund i. In this example, the percentile rank of return refers to an expression of annualized return, computed over a specified time interval, e.g., over the date range entered by the user 132. The standard deviation of returns refers to the standard deviation of annualized returns computed over the specified time interval. The asset change refers to the percent change in the value of assets from the beginning to the ending of the date range. The “ending assets” value refers to the numerical value of assets at the end of the date range.

Thus, for each pairwise comparison between the target fund T and each comparison fund i, the difference metric Xᵢ may be computed according to equation 600 in some example embodiments. Each of these difference metrics may then be ordered or ranked to determine which fund is most similar to the target fund. In some example embodiments, additional statistics quantitatively describing the funds may be used to compute the difference metric. Examples can include a number and types of industry sectors diversified in the funds, and an amount of assets (either in absolute value or percentage) within each industry.

In some example embodiments, additional types of information related to the funds can be compared. Besides 1) statistical information about the funds, examples can include: 2) demographic information about the fund manager and/or employees servicing the fund (e.g., levels of education, gender, age, cultures of origin, etc.), 3) organizational information about the fund company (e.g., total assets under management, number of employees, inception date, location, etc.), 4) behavioral/psychological information about the fund manager and other employees generated from the use of assessments or from the analysis of material and products generated by the funds, 5) information about investors in the funds (e.g., type of investors, geographical composition, investment goals of the investors, psychological profiles of the investors, etc.), 6) information about people and organizations associated with the fund (e.g., legal representation, fund administrators, auditors, etc.), 7) any social or organizational network information about the fund, and 8) ratings or evaluations from critics or others about the funds (e.g., investors' satisfaction ratings of funds, systematic behavioral “tags” assigned to the fund by outside computer programmers using systematic tagging instructions). Other types of information consistent with the descriptions herein and apparent to this with skill in the art may also be used, and embodiments are not so limited. For clarity, these types of information described herein can collectively be called “fund characteristics.” Thus, in some example embodiments, the methods described in FIG. 5 can include not only the statistics discussed therein but also various other types of fund characteristics mentioned herein.

In some example embodiments, these fund characteristics can be ranked with respect to each comparison fund and then compared in similar methods described herein. For example, the difference metric can include: a ranking of fund managers according to level of education (e.g., type and number of degrees of managers), a ranking of fund managers according to prior work history (e.g., years of experience, having worked/trained at longer-established funds), and a ranking of a measure of similarity of investment philosophy and strategy as stated in written communications such as marketing materials or letters. This may be measured by comparing the number and placement of words appearing in two different texts, for example. More overlap, by number and by placement, can indicate greater similarity, for example. Additional rankings can also include a ranking of comparison funds according to an amount of fees charged to investors.

In some example embodiments, other types of equations or functions may be used to determine the difference metrics. Example equations can include squared Euclidean distance, Manhattan distance, chessboard distance, cosine distance, correlation distance. Jaccard dissimilarity, matching dissimilarity, edit distance, as well as performing regression analysis. Other methods apparent to those with skill in the art are also possible, and embodiments are not so limited.

In some example embodiments, weights can be included into calculating the difference metrics, where the weights can assign relative degrees of importance to the statistics or other fund characteristics. For example, the equation 600 can offset each comparison of statistics by a weight Kₙ for each of n statistics or other factors used to calculate the Euclidean distance. For example, each Kₙ can range from 0 to 1 and can be a multiplicative factor for each comparison of statistics, e.g., K_{R}*(R_{T}−Rᵢ)²+K_{AC}*(AC_{T}−ACᵢ)² and so on.

In some example embodiments, the find similar funds tool 200 can also be configured to accept user inputs to select which types of fund characteristics are desired to be used for comparison purposes. For example, aside from selecting the target fund 305 and the date range via a slider bar 310 or other user interface, the user 132 can also select fund characteristics from a drop-down menu. In some example embodiments, the tool 200 can also be configured to accept weight inputs from the user 132. For example, the user 132 may place higher importance on certain characteristics, like rate of growth, but then may also want to place minor importance on demographics of the fund personnel. A drop-down menu may also include spaces to include weights for each fund characteristics, in some example embodiments.

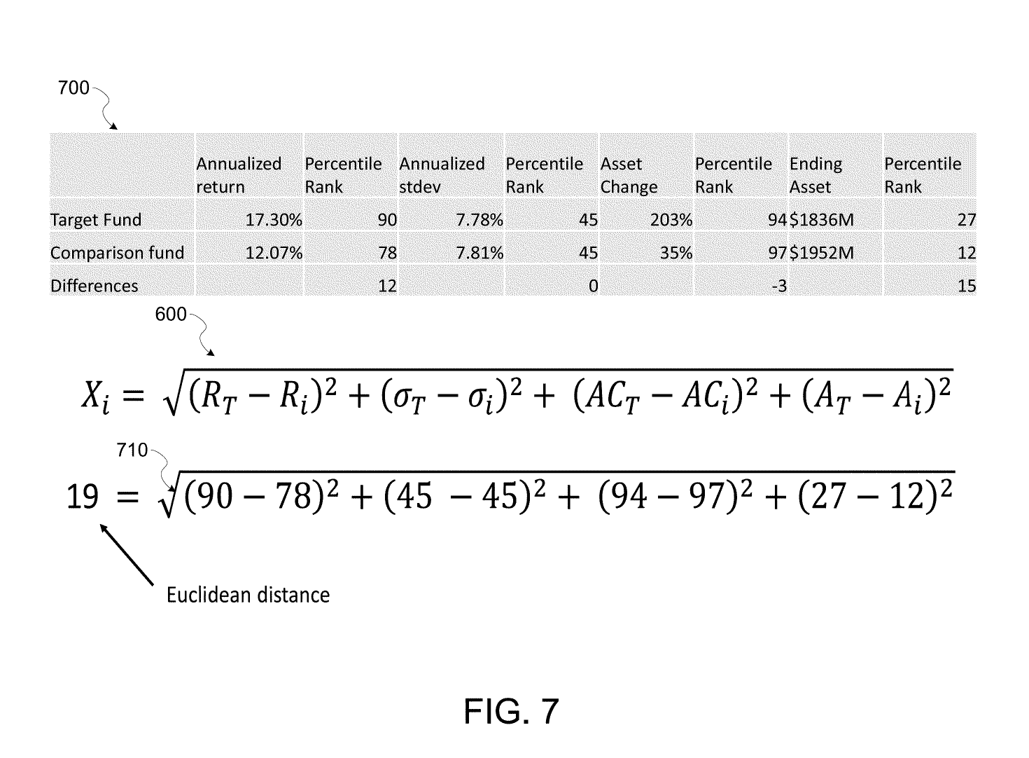

Referring to FIG. 7, a concrete example of computing a measure of difference or similarity between a target fund and a comparison fund in a database is shown, according to some example embodiments. Chart 700 provides numerical examples used to compute a difference metric between the target fund and the comparison fund. Here, the same four statistics described in FIG. 6 in the same example equation 600 are used. However, in this case, the percentile rankings of each of the statistics for the target fund and the comparison fund are used rather than the raw values of each of the statistics, and embodiments are not so limited. A computation of the Euclidean distance using the example numerical values from chart 700 are shown in equation 710. Thus, the Euclidean distance of 19 represents the difference metric between the target fund and this particular comparison fund. Similarly, difference metrics between the target fund and all other comparison funds may be computed, and then their values may be ordered. The comparison funds in the database, e.g., database 115, having the smallest difference metric values may then be considered to be most similar to the target fund, and these funds may then be displayed to the user 132.

Referring to FIG. 8, the block diagram illustrates components of a machine 800, according to some example embodiments, able to read instructions 824 from a machine-readable medium 822 (e.g., a non-transitory machine-readable medium, a machine-readable storage medium, a computer-readable storage medium, or any suitable combination thereof) and perform any one or more of the methodologies discussed herein, in whole or in part. Specifically, FIG. 8 shows the machine 800 in the example form of a computer system (e.g., a computer) within which the instructions 824 (e.g., software, a program, an application, an applet, an app, or other executable code) for causing the machine 800 to perform any one or more of the methodologies discussed herein may be executed, in whole or in part.

In alternative embodiments, the machine 800 operates as a standalone device or may be connected (e.g., networked) to other machines. In a networked deployment, the machine 800 may operate in the capacity of a server machine 110 or a client machine in a server-client network environment, or as a peer machine in a distributed (e.g., peer-to-peer) network environment. The machine 800 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 824, sequentially or otherwise, that specify actions to be taken by that machine. Further, while only a single machine 800 is illustrated, the term “machine” shall also be taken to include any collection of machines that individually or jointly execute the instructions 824 to perform all or part of any one or more of the methodologies discussed herein.

The machine 800 includes a processor 802 (e.g., a central processing unit (CPU), a graphics processing unit (CPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more modules (e.g., software modules) described herein.

The machine 800 may further include a video display 810 (e.g., a plasma display panel (PDP), a light emitting diode (LED) display, a liquid crystal display (LCD), a projector, a cathode ray tube (CRT), or any other display capable of displaying graphics or video). The machine 800 may also include an alphanumeric input device 812 (e.g., a keyboard or keypad), a cursor control device 814 (e.g., a mouse, a touchpad, a trackball, a joystick, a motion sensor, an eye tracking device, or other pointing instrument), a storage unit 816, a signal generation device 818 (e.g., a sound card, an amplifier, a speaker, a headphone jack, or any suitable combination thereof), and a network interface device 820.

The storage unit 816 includes the machine-readable medium 822 (e.g., a tangible and non-transitory machine-readable storage medium) on which are stored the instructions 824 embodying any one or more of the methodologies or functions described herein, including, for example, any of the descriptions of FIGS. 1-7. The instructions 824 may also reside, completely or at least partially, within the main memory 804, within the processor 802 (e.g., within the processor's cache memory), or both, before or during execution thereof by the machine 800. The instructions 824 may also reside in the static memory 806.

Accordingly, the main memory 804 and the processor 802 may be considered machine-readable media 822 (e.g., tangible and non-transitory machine-readable media). The instructions 824 may be transmitted or received over a network 826 via the network interface device 820. For example, the network interface device 820 may communicate the instructions 824 using any one or more transfer protocols (e.g., HTTP). The machine 800 may also represent example means for performing any of the functions described herein, including the processes described in FIGS. 1-7.

In some example embodiments, the machine 800 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 822 able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database 115, or associated caches and servers) able to store instructions 824. The term “machine-readable medium” shall also be taken to include any medium, or combination of multiple media, that is capable of storing the instructions 824 for execution by the machine 800, such that the instructions 824, when executed by one or more processors of the machine 800 (e.g., processor 802), cause the machine 800 to perform any one or more of the methodologies described herein, in whole or in part. Accordingly, a “machine-readable medium” refers to a single storage apparatus or device 130 or 150, as well as cloud-based storage systems or storage networks that include multiple storage apparatus or devices 130 or 150. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 822 is non-transitory in that it does not embody a propagating signal. However, labeling the tangible machine-readable medium 822 as “non-transitory” should not be construed to mean that the medium 822 is incapable of movement; the medium 822 should be considered as being transportable from one physical location to another. Additionally, since the machine-readable medium 822 is tangible, the medium 822 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 822 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 802 or a group of processors 802) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 802 or other programmable processor 802. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 808) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions described herein. As used herein, “processor-implemented module” refers to a hardware module implemented using one or more processors 802.

Similarly, the methods described herein may be at least partially processor-implemented, a processor 802 being an example of hardware. For example, at least some of the operations of a method may be performed by one or more processors 802 or processor-implemented modules. As used herein, “processor-implemented module” refers to a hardware module in which the hardware includes one or more processors 802. Moreover, the one or more processors 802 may also operate to support performance of the relevant operations in a “cloud computing” environment or as a “software as a service” (SaaS). For example, at least some of the operations may be performed by a group of computers (as examples of machines 800 including processors 802), with these operations being accessible via a network 826 (e.g., the Internet) and via one or more appropriate interfaces (e.g., an API).

The performance of certain operations may be distributed among the one or more processors 802, not only residing within a single machine 800, but deployed across a number of machines 800. In some example embodiments, the one or more processors 802 or processor-implemented modules may be located in a single geographic location (e.g., within a home environment, an office environment, or a server farm). In other example embodiments, the one or more processors 802 or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine 800 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing one or more databases including:
target fund characteristics data of a target fund, the target fund characteristics data describing at least one former characteristic of the target fund;
first comparison fund characteristics data of a first comparison fund, the first comparison fund characteristics data describing at least one present characteristic of the first comparison fund;
second comparison fund characteristics data of a second comparison fund, the second comparison fund characteristics data describing at least one present characteristic about the second comparison fund;
calculating, by one or more processors of a machine, a first difference metric between the target fund and the first comparison fund based on the target fund characteristics data and the first comparison fund characteristics data, the first difference metric indicating a measure of similarity between the at least one former characteristic of the target fund and the at least one present characteristic of the first comparison fund;
calculating, by the one or more processors of the machine, a second difference metric between the target fund and the second comparison fund based on the target fund characteristics data and the second comparison fund characteristics data, the second difference metric indicating a measure of similarity between the at least one former characteristic of the target fund and the at least one present characteristic of the second comparison fund;
ranking, by the one or more processors of the machine, the first and the second difference metrics; and
by the one or more processors of the machine, causing display of a visual presentation that lists the first and second comparison funds in accordance with the ranked first and second difference metrics by a graphical display.

2. The method of claim 1, wherein the target fund characteristics data include a measure of return of the target fund indicating annualized return of the target fund over a time interval, a standard deviation of returns indicating a standard deviation of annualized returns of the target fund computed over a time interval, or a measure of asset change indicating a percent change in value of assets of the target fund over a time interval.

3. The method of claim 1, wherein the target fund characteristics data include demographic information about a fund manager servicing the target fund.

4. The method of claim 1, wherein the target fund characteristics data include behavioral/psychological information about a fund manager generated from psychological assessments or from analysis of quantitative material and products describing the target fund.

5. The method of claim 1, wherein the target fund characteristics data include ratings information describing a measure of satisfaction about the target fund.

6. The method of claim 1, further comprising:
accessing, by the one or more processors of the machine, a date range of the target fund, the date range including a beginning date and an ending date during which the target fund operated;
and wherein:
the accessing of the one or more databases including the target fund characteristics data includes accessing the target fund characteristics data of the target fund within a first time interval from the beginning date to the ending date;
the accessing of the one or more databases including the first comparison fund characteristics data includes accessing the first comparison fund characteristics data within a second time interval from a length of the beginning date to the ending date and ending at the present day; and
the accessing of the one or more databases including the second comparison fund characteristics data includes accessing the one or more second comparison fund characteristics within the second time interval.

7. The method of claim 1, wherein the generating of the first difference metric between the target fund and the first comparison fund includes computing a Euclidian distance based on the target fund characteristics data and the first comparison fund characteristics data.

8. The method of claim 7, wherein the Euclidian distance is based further on percentile rankings of the target fund characteristics data and the first comparison fund characteristics data.

9. The method of claim 1, further comprising:
generating a first similarity score for the first comparison fund, the first similarity score indicating how similar the first comparison fund is to the target fund, the first similarity score based on an aggregate of characteristics based on a normalization of a ranking of the first and second difference metrics; and
causing display of the first similarity score.

10. A system comprising:
a memory;
at least one processor coupled to the memory and configured to:
access target fund characteristics data of a target fund, the target fund characteristics data describing at least one former characteristic of the target fund;
access first comparison fund characteristics data of a first comparison fund, the first comparison fund characteristics data describing at least one present characteristic of the first comparison fund;
access second comparison fund characteristics data of a second comparison fund, the second comparison fund characteristics data describing at least one present characteristic of the second comparison fund;
calculate a first difference metric between the target fund and the first comparison fund based on the target fund characteristics data and the first comparison fund characteristics data, the first difference metric indicating a measure of similarity between the at least one former characteristic of the target fund and the at least one present characteristic of the first comparison fund;
generate a second difference metric between the target fund and the second comparison fund based on the target fund characteristics data and the second comparison fund characteristics data, the second difference metric indicating a measure of similarity between the at least one former characteristic of the target fund and the at least one present characteristic of the second comparison fund;
rank the first and the second difference metrics; and
cause display of a visual presentation that lists the first and second comparison funds in accordance with the ranked first and second difference metrics by a graphical display.

11. The system of claim 10, wherein the target fund characteristics data include a measure of return of the target fund indicating annualized return of the target fund over a time interval, a standard deviation of returns indicating a standard deviation of annualized returns of the target fund computed over a time interval, or a measure of asset change indicating a percent change in value of assets of the target fund over a time interval.

12. The system of claim 10, wherein the target fund characteristics data include demographic information about a fund manager servicing the target fund.

13. The system of claim 10, wherein the target fund characteristics data include behavioral/psychological information about a fund manager generated from psychological assessments or from analysis of quantitative material and products describing the target fund.

14. The system of claim 10, wherein the target fund characteristics data include ratings information describing a measure of satisfaction about the target fund.

15. The system of claim 10, wherein the at least one processor is further configured to:
access a date range of the target fund, the date range including a beginning date and an ending date during which the target fund operated;
and wherein:
the accessing of the target fund characteristics data includes accessing the target fund characteristics data of the target fund within a first time interval from the beginning date to the ending date;
the accessing of the first comparison fund characteristics data includes accessing the first comparison fund characteristics data within a second time interval from a length of the beginning date to the ending date and ending at the present day; and
the accessing of the second comparison fund characteristics data includes accessing the second comparison fund characteristics data within the second time interval.

16. The system of claim 10, wherein the generating of the first difference metric between the target fund and the first comparison fund includes computing a Euclidian distance based on the target fund characteristics data and the first comparison fund characteristics data.

17. The system of claim 16, wherein the Euclidian distance is based further on percentile rankings of the target fund characteristics data and the first comparison fund characteristics data.

18. The system of claim 1, wherein the at least one processor is further configured to:
generate a first similarity score for the first comparison fund, the first similarity score indicating how similar the first comparison fund is to the target fund, the first similarity score based on an aggregate of characteristics based on a normalization of a ranking of the first and second difference metrics; and
cause display of the first similarity score.

19. A computer-readable medium embodying instructions that, when executed by a processor, perform operations comprising:
accessing target fund characteristics data of a target fund, the target fund characteristics data describing at least one former characteristic about the target fund;
one or more first comparison fund characteristics data of a first comparison fund, the first comparison fund characteristics data describing at least one present characteristic of the first comparison fund;
accessing second comparison fund characteristics data of a second comparison fund, the second comparison fund characteristics data describing at least one present characteristic of the second comparison fund;
generating a first difference metric between the target fund and the first comparison fund based on the target fund characteristics data and the first comparison fund characteristics data, the first difference metric indicating a measure of similarity between the at least one former characteristic of the target fund and the at least one present characteristic of the first comparison fund;
generating a second difference metric between the target fund and the second comparison fund based on the target fund characteristics data and the second comparison fund characteristics data, the second difference metric indicating a measure of similarity between the at least one former characteristic of the target fund and the at least one present characteristic of the second comparison fund;
ranking the first and the second difference metrics; and
causing display of a visual presentation that lists the first and second comparison funds in accordance with the ranked first and second difference metrics by a graphical display.

20. The computer-readable medium of claim 19, the operations further comprising:
accessing a date range of the target fund, the date range including a beginning date and an ending date during which the target fund operated;
and wherein:
the accessing of the target fund characteristics data includes accessing the target fund characteristics data of the target fund within a first time interval from the beginning date to the ending date;
the accessing of the first comparison fund characteristics data includes accessing the first comparison fund characteristics data within a second time interval from a length of the beginning date to the ending date and ending at the present day; and
the accessing of the second comparison fund characteristics data includes accessing the second comparison fund characteristics within the second time interval.
